(19) United States
(12) Patent Application Publication
(10) Pub. No.: US 2023/0358906 A1
(43) Pub. Date: Nov. 9, 2023

(54) APPARATUS AND METHOD FOR INSTALLING SENSOR DEVICE TO ACHIEVE A KNOWN MAGNETIC ORIENTATION

(71) Applicant: United States of America as Represented by The Secretary of The Army, Alexandria, VA (US)

(72) Inventors: Rebekah F Lee, Vicksburg, MS (US); Rongmao Zhou, Vicksburg, MS (US); Gustavo Galan-Comas, Vicksburg, MS (US); Roland Fuentes, Meridianville, AL (US); Lawrence Watkins, Meridianville, AL (US)

(21) Appl. No.: 17/735,891

(22) Filed: May 3, 2022

(51) Int. Cl. E21B 41/00; G01V 1/18; G01V 1/52

(52) U.S. Cl. CPC G01V 1/181; E21B 41/00; G01V 1/52

(57) ABSTRACT

In one embodiment, an apparatus for installing a sensor device to achieve a known magnetic orientation includes a distal tilt sensor configured to be attached to the sensor device to be installed into a borehole; an installation tool configured to be detachably connected to the sensor device at or near a distal end of the installation tool to install the sensor device into the borehole; and an orientation sensor configured to be attached to the installation tool at a location proximal of the distal end of the installation tool toward a proximal end of the installation tool, the orientation sensor including a compass and a proximal tilt sensor.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present invention relates to apparatus and methods of installing a sensor device and, more particularly, installing a sensor device in a borehole on the ground to achieve a known magnetic orientation.

### Description of the Related Art

This section introduces aspects that may help facilitate a better understanding of the invention. Accordingly, the statements of this section are to be read in this light and are not to be understood as admissions about what is prior art or what is not prior art.

Installing a sensor device such as a seismic sensing device that is magnetically orientated with respect to the earth’s magnetic poles is important to achieve accurate sensor measurements. When the sensor device is installed in a borehole (e.g., in the ground), it is a challenge to achieve a known magnetic orientation, especially if the sensor device is placed into the borehole of any significant depth. Ideally, during placement of the sensor device, the sensor device maintains a straight orientation (e.g., vertically straight) while being inserted into a straight borehole. In reality, however, errors occur when the borehole is not straight (e.g., angled), the sensor device is tilted at an angle during insertion, or both the borehole is angled and the sensor device is tilted. While the operator on the surface may believe the sensor device is being installed at a certain bearing (e.g., magnetic North or true North) and is perfectly leveled, in reality the sensor device may be off from the bearing and is tilted inside the borehole. Errors in installation of the sensor device will result in errors in measurement by the sensor device, rendering the sensing results unreliable or useless.

### SUMMARY

The present invention was developed to address the desire for an apparatus and a method for installing a sensor device into a borehole to achieve a known orientation of the sensor device, for instance, which is automatically aligned to common direction (e.g., North) and at or near level orientation with no tilt or negligible tilt (e.g., less than 0.1% deviation). The installed sensor device can deviate in tilt due to an angled borehole or an angled sensor during installation. The tilt deviation can be mitigated by making sure the installed sensor device is level. It is further desirable that the installed sensor device has precise coordinates and good sensor coupling to provide sensor measurement results outside of the borehole. An example of the sensor device is a geophone or a SPOT (Satellite Pour I′Observation de la Terre) sensor used for SPOT which is a commercial high-resolution optical Earth imaging satellite system operating from space. The geophone or SPOT sensor is installed vertically inside a borehole into the ground.

According to an aspect the present invention, an apparatus for installing a sensor device to achieve a known magnetic orientation comprises a distal tilt sensor configured to be attached to the sensor device to be installed into a borehole; an installation tool configured to be detachably connected to the sensor device at or near a distal end of the installation tool to install the sensor device into the borehole; and an orientation sensor configured to be attached to the installation tool at a location proximal of the distal end of the installation tool toward a proximal end of the installation tool, the orientation sensor including a compass and a proximal tilt sensor.

In accordance with another aspect of this invention, a method for installing a sensor device to achieve a known magnetic orientation, the method comprising: attaching a distal tilt sensor to the sensor device; detachably connecting an installation tool to the sensor device at or near a distal end of the installation tool; attaching an orientation sensor to the installation tool at a location proximal of the distal end of the installation tool toward a proximal end of the installation tool, the orientation sensor including a compass and a proximal tilt sensor; lowering the sensor device into the borehole; orientating the sensor device to achieve a known magnetic orientation based on the compass and tilt sensor measurements from the compass, the proximal tilt sensor, and the distal tilt sensor; and setting the sensor device fixed in position inside the borehole.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 illustrates a front elevational view of an installation apparatus for installing a sensor device to achieve a known magnetic orientation of the sensor device according to an embodiment of the present invention.

FIG. 2A is a front elevational view showing additional details of the installation apparatus of FIG. 1 including the use of a tilt sensor on the sensor device to be installed near the distal end of the installation rod and a compass and tilt sensor near the proximal end of the installation rod.

FIG. 2B is a front elevational view of the installation apparatus of FIG. 2A illustrating an angled sensor device which is tilted during installation.

FIG. 3A is a perspective view of an installation head according to an embodiment.

FIG. 3B is an exploded perspective view of the installation head of FIG. 3A.

FIG. 3C is a front elevational view of the installation head of FIG. 3A.

FIG. 3D is a side elevational view of the installation head of FIG. 3A.

FIG. 3E is a plan view of a magnetic retainer of the installation head of FIG. 3A.

FIG. 4 is a view of the sensor device assembly showing attachment of the tilt sensor.

FIG. 5 is a view of the installation bar near the proximal end showing attachment of the orientation sensor.

FIG. 6 illustrates an example of a borehole camera including (A) a perspective view, (B) a front elevational view, (C) a right side view, (D) a rear elevational view, (E) a left side view, and (F) a bottom plan view thereof.

FIGS. 7A-7B illustrate details of the cable connections between the tilt sensor module and a laptop computer at the surface above ground and of the cable connections between the orientation sensor module and the laptop computer at the surface above ground.

FIG. 8 illustrates cable set #1 having the cable connections of FIGS. 7A-7B and a first set of cable markers.

FIG. 9 illustrates cable set #2 having the cable connections of FIGS. 7A-7B and a second set of cable markers.

FIG. 10 illustrates an example of cable lines connecting the tilt sensor module and the computer and of cable lines connecting the orientation sensor module and the computer at the surface above ground.

FIG. 11A shows an example of Option #1 of cable connections based on the configuration of cable lines in FIG. 10.

FIG. 11B shows an example of Option #2 of cable connections based on the configuration of cable lines in FIG. 10.

FIG. 12 is a view of the sensor device assembly and installation tool illustrating another example of the cable connections

FIG. 13 is an example of the orientation sensor circuit of the orientation sensor.

FIG. 14 is an example of a compass reading output format for the orientation sensor circuit showing (A) North, (B) South, (C) West, and (D) East.

FIG. 15 is a view of a compass showing an example of magnetic declination. showing a compass needle with a positive (or easterly) variation from geographic North.

FIG. 16 is an example of tilt output values in the Y axis for (A) the orientation sensor circuit and (B) the tilt sensor circuit.

FIG. 17 is an example of tilt output values in the X axis for (A) the orientation sensor circuit and (B) the tilt sensor circuit.

FIG. 18 is an example of a flow diagram illustrating a sensor device installation process.

FIG. 19 shows the orientation sensor module to be calibrated, in (A) side view, (B) back view, (C) front view, and (D) top view.

FIG. 20 shows rotation of the orientation sensor module for calibration around the three axes along (A) the Z axis, (B) the X axis, and (C) the Y axis.

FIG. 21 illustrates removal of the orientation sensor module from the installation bar 160.

FIG. 22 illustrates connecting the removed orientation sensor module of FIG. 21 to the computer.

FIG. 23 shows rotation of the orientation sensor module for calibration on (A) the XY plane, (B) the YZ plane, and (C) the XZ plane.

FIG. 24 shows the sensor device assembly and the installation tool set up for tilt calibration.

FIG. 25 shows the sensor device assembly and the installation tool hanging straight vertically for zero tilt calibration.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Embodiments of the present invention provide apparatus and methods of installing a sensor device such as a geophone sensor in a borehole on the ground to achieve a known magnetic orientation.

### Sensor Device Installation Apparatus

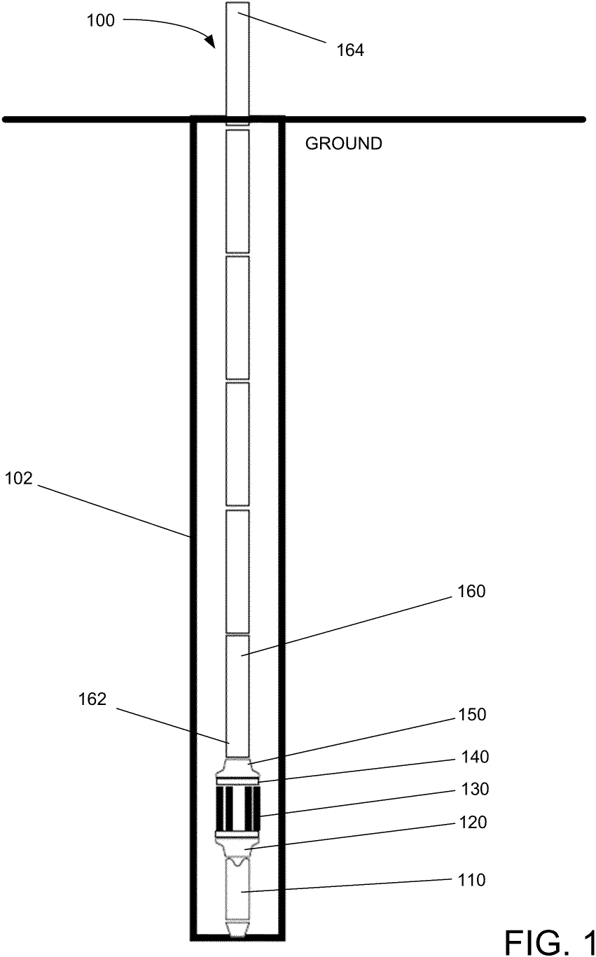

FIG. 1 illustrates a front elevational view of an installation apparatus 100 for installing a sensor device to achieve a known magnetic orientation of the sensor device according to an embodiment of the present invention. A borehole 102 is prepare in the ground which may be a vertical hole of a substantial depth. For instance, the depth may be several times to over ten times the size of the sensor device 110 to be installed (e.g., over 1 meter deep). The sensor device 110 may be a geophone or SPOT sensor device 110 housed in sensor hardware that includes, for example, a sensor device casing or housing 120. A plurality of support rods 130 (e.g., four) and a metal plate 140 are attached to the sensor device housing 120 and together form a sensor device assembly that moves as one. The support rods 130 and metal plate 140 provide a mechanism to attach the sensor device 110 to an installation tool for installing the sensor device 110 into the borehole 102.

The installation tool includes an installation head 150 that attaches to and detaches from the sensor hardware. In one embodiment as shown, the installation head 150 is a magnetic head that provides a magnetic breakaway connection to the metal plate 140. An installation rod 160 is attached to the installation head 150 to lower the sensor device assembly into the borehole 102. The rod 160 may include a plurality of tool/rod segments extending from a distal end 162 at the installation head 150 to a proximal end 164 exposed above the ground. The installation rod 160 also serves as a conduit for water into the borehole to mix with the quick-setting concrete to set concrete on the installed sensor device assembly. The support rods 130 and metal plate 140 facilitate installation of the sensor device 110 and, as part of the sensor device assembly, stay underground with the installed sensor device 110 and casing 120. The installation head 150 and installation rod 160 are part of the overall installation system that is detached from the sensor device assembly and removed from the ground.

Before installing the sensor device 110, the operator scopes and observes the borehole conditions and records the depth of the borehole 102. The operator attaches the sensor device assembly to the magnetic installation head 150 and the installation rod 160. The sensor device 110 may be a three component (3C) sensor having a vertical component and two horizontal components. The operator may add tool/rod segments to the installation rod 160 to increases its length to place the sensor device 110 at the bottom of the borehole 102. The operator then lowers or delivers quick-setting concrete powder down the borehole 102 and orientate the sensor device 110 before adding water and waiting for the quick-setting concrete to set. The sensor device 110 is magnetically orientated and aligned by manipulating the installation rod 160 from outside the borehole 102. The operator may make use of a digital compass on the surface. After setting of the concrete, the operator may take alignment measurements of the sensor device 110 again using the digital compass. After confirming that the sensor device 110 is planted, the operator pulls up the installation tool and may fill in the borehole 102 with native soil. The operator records the GPS (Global Positioning System) location of the sensor device 110.

A proper installation is achieved when there is good sensor coupling to provide sensor measurement results outside of the borehole, a known orientation of the sensor device (e.g., automatically aligned to common direction and at or near level orientation with no tilt or negligible tilt, and precise coordinates of the installed sensor device 110. The installation apparatus of the present invention is configured to facilitate such proper installations.

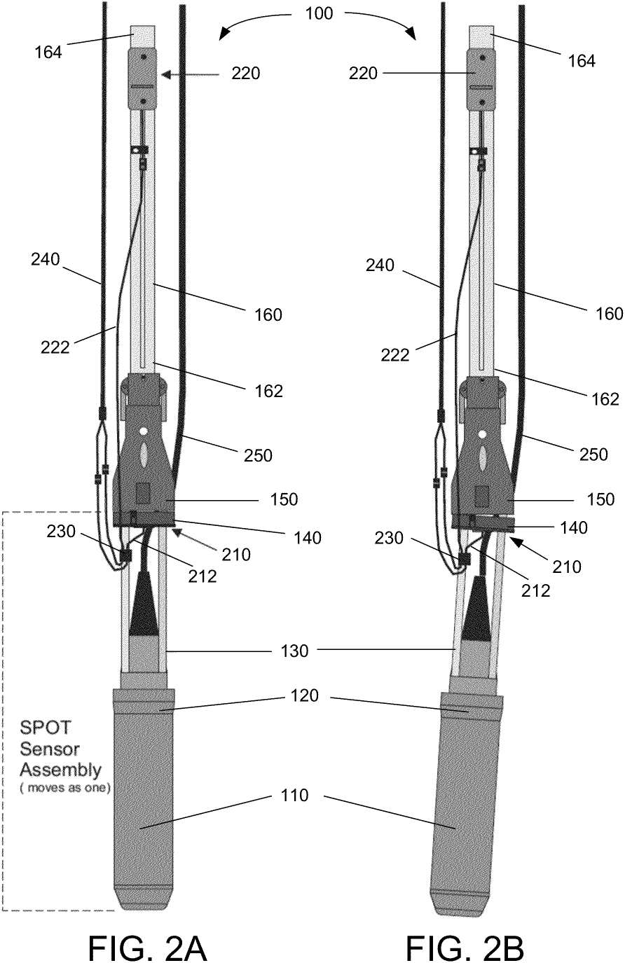

FIG. 2A is a front elevational view showing additional details of the installation apparatus 100 of FIG. 1. It includes the use of a tilt sensor 210 (also referred to as distal tilt sensor) on the sensor device 110 to be installed near the distal end 162 of the installation rod 160 (e.g., within a few cm) and an orientation sensor 220 near the proximal end 164 of the installation rod 160 (e.g., within a few cm). The orientation sensor 220 may include a compass and a tilt sensor (also referred to as proximal tilt sensor) to achieve a known magnetic orientation of the installation rod 160 and measure any tilting of the installation rod 160. The distal tilt sensor 210 is attached to the sensor device 110 at or near the distal end 162 of the installation rod 160 to install the sensor device 110 into the borehole 102. The orientation sensor 220 is attached to the installation rod 160 at a location proximal of the distal end 162 toward a proximal end 164 of the installation rod 160.

A tilt sensor cable 212 connects the tilt sensor 210 via a breakaway cable connector 230 to a major cable 240 which leads to the surface above ground. A proximal sensor cable 222 connects the orientation sensor 220 via the breakaway cable connector 230 to the major cable 240. A sensor cable 250 (also referred to as geophone cable) is connected via the sensor device casing 120 to the sensor device 110 and leads to the surface above ground. A proper installation will result in alignment of the tilt sensor 210 and the orientation sensor 220 vertically in the borehole 102. Tilt sensors are used to measure the tilt in multiple axes of a reference plane. They measure the tilting position with reference to gravity. Tilt sensors and digital compasses are commercially available.

FIG. 2B is a front elevational view of the installation apparatus 100 of FIG. 2A illustrating an angled sensor device 110 which is tilted during installation. The sensor device 110 is tilted relative to the installation tool and they are no longer aligned vertically in the borehole 102. The tilting can happen even if the borehole 102 is straight and the sensor device assembly and the installation tool are lowered into the borehole 102 carefully.

The tilt sensor 210 and the orientation sensor 220 are used to measure the magnetic orientation and tilt of the sensor device 110 during installation. They ensure that the sensor device 110 is aligned with the installation tool and with vertical and is magnetically orientated with respect to a known direction such as the earth’s magnetic poles. The tilt sensor 210 and the orientation sensor 220 enable the operator to monitor in real time the tilt relationship between the tilt sensor 210 and the orientation sensor 220 and the tilt of these sensors to vertical. Mitigating the tilt ensures that the installed sensor device 110 is level.

In the embodiment shown, the tilt sensor 210 is attached or affixed to the metal plate 140 (also referred to as the distal tilt sensor plate) of the sensor device assembly at or near the distal end 162 of the installation rod 160 (e.g., within a few cm). The orientation sensor 220 is attached to the installation rod 160 near its proximal end 164 to measure tilt and magnetic orientation of the installation rod 160. In this way, the compass of the orientation sensor 220 does not suffer from magnetic interference by the magnetic field of the magnetic installation head 150 that is used to temporarily connect to the sensor device assembly via a breakaway magnetic connection. The tilt sensor 210 may be embedded in the metal plate 140 to measure tilt of the sensor device assembly and stays with the sensor device assembly in the borehole 102 after installation.

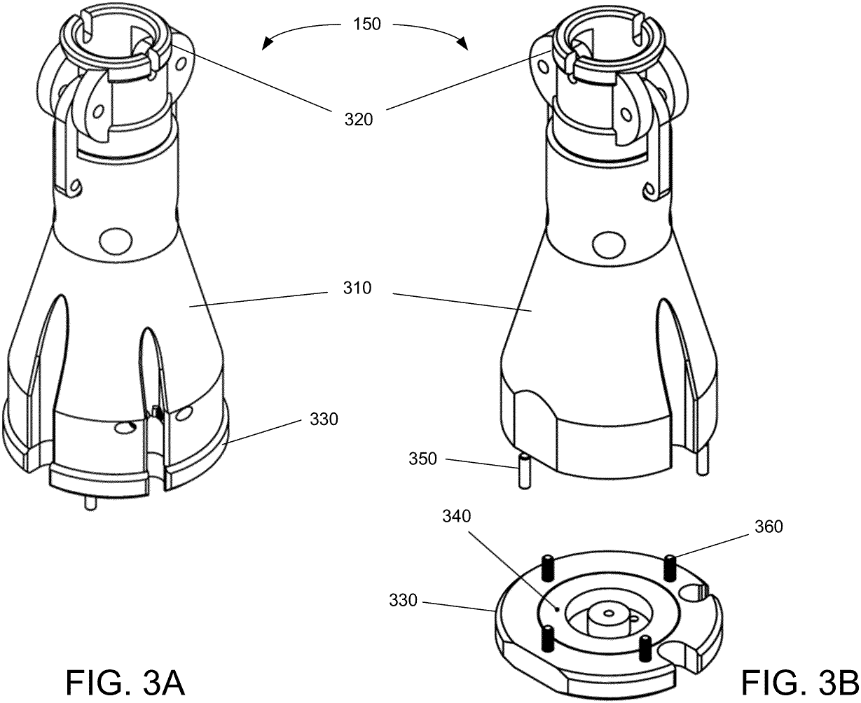

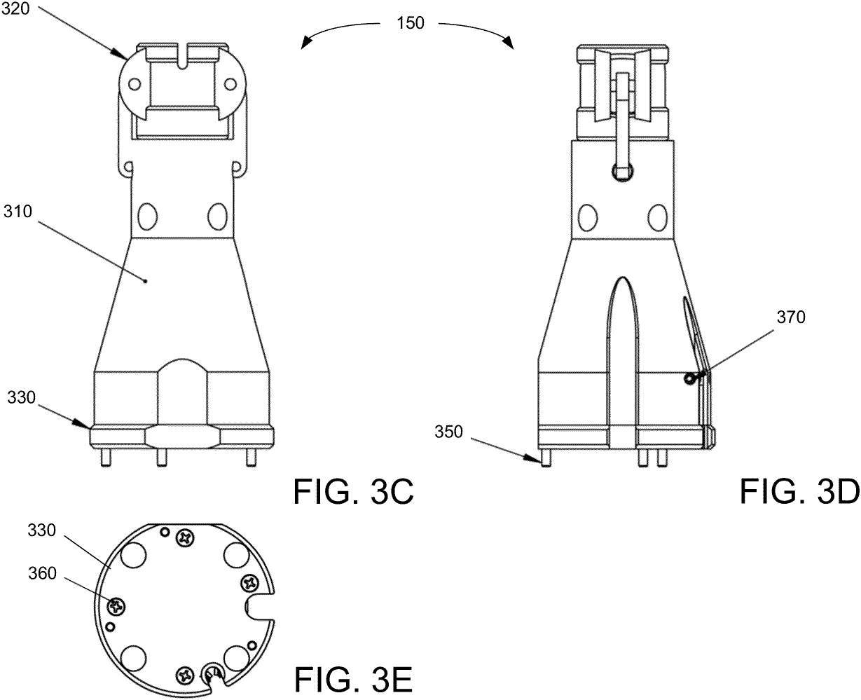

FIG. 3A is a perspective view of an installation head 150 according to an embodiment. FIG. 3B is an exploded perspective view thereof. FIG. 3C is a front elevational view thereof. FIG. 3D is a side elevational view thereof. The installation head 150 may be a magnetic head. It includes a body 310, a socket 320 (e.g., a SPOT modified camlock socket), a magnetic alignment ring 330, a magnetic retainer 340, three dowel pins 350 (e.g., to align with the metal plate 140), four screws 360 (e.g., Phillips flat head screws), and two set screws 370 (e.g., nylon-tip set screws). FIG. 3E is a plan view of a magnetic alignment ring 330 of the installation head of FIG. 3A. The screws 360 attach the magnetic alignment ring 330 to the body 310. The magnetic alignment ring 330 and magnetic retainer 340 form a magnetic member or magnetic plate to provide a magnetic breakaway connection with the metal plate 140.

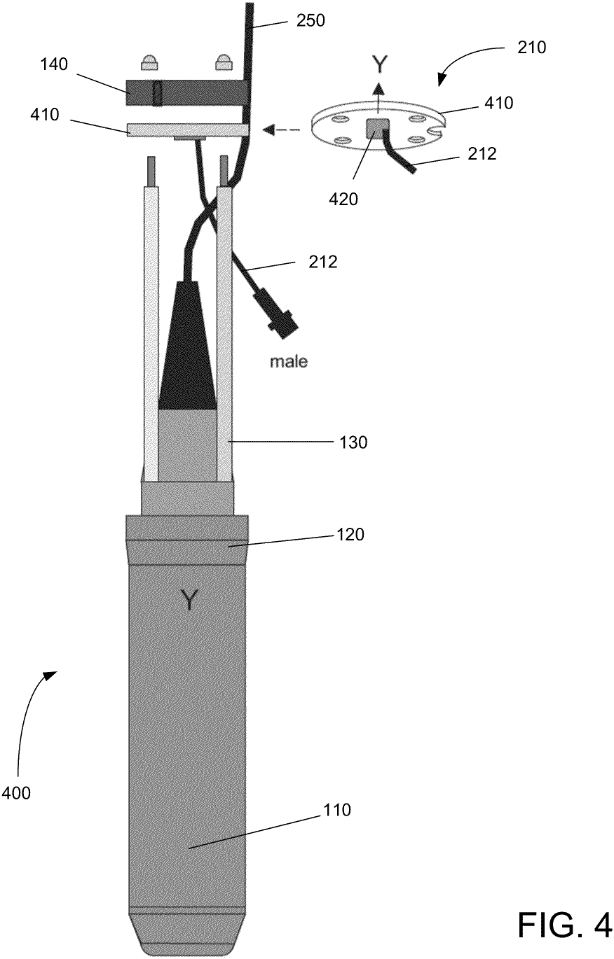

FIG. 4 is a view of the sensor device assembly 400 showing attachment of the tilt sensor 210. The tilt sensor or tilt sensor module 210 includes a tilt sensor coupling plate 410, a tilt sensor circuit 420 affixed to the tilt sensor coupling plate 410, and a tilt sensor cable 212 connecting the tilt sensor circuit 420 to the major cable 240 via the breakaway cable connector 230 in FIG. 2. The support rods 130 may have threaded ends that are connected to the metal plate 140 by threaded nuts with the tilt sensor module 210 disposed between the support rods 130 and the metal plate 140. The sensor or geophone cable 250 is connected via the sensor device casing 120 to the sensor device 110. FIG. 4 shows the Y axis to which the sensor device 110 is pointed (out of the page). The Y axis is a known direction such as true North. The components shown in FIG. 4 may be considered disposable and be left in the borehole 102 permanently.

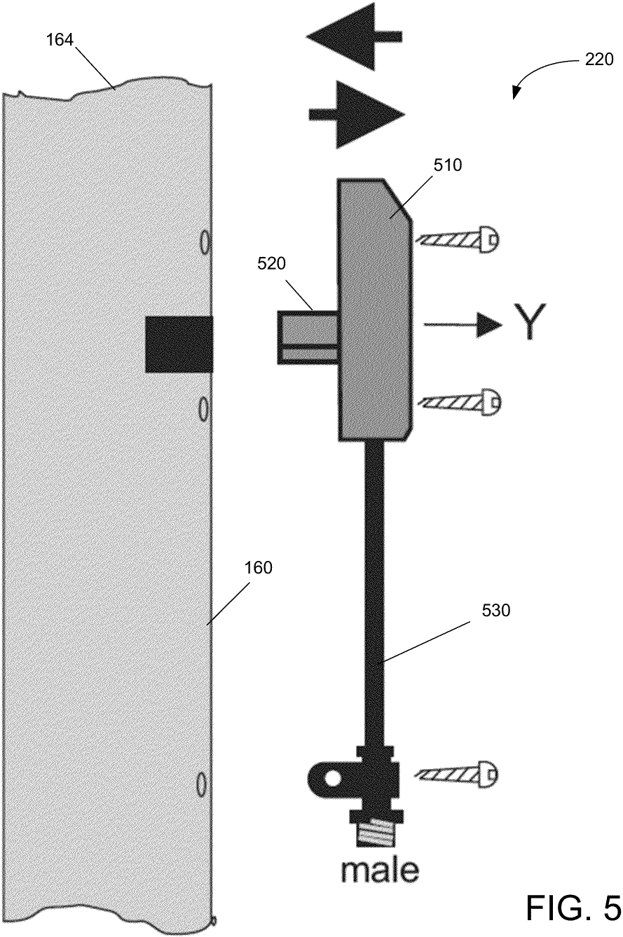

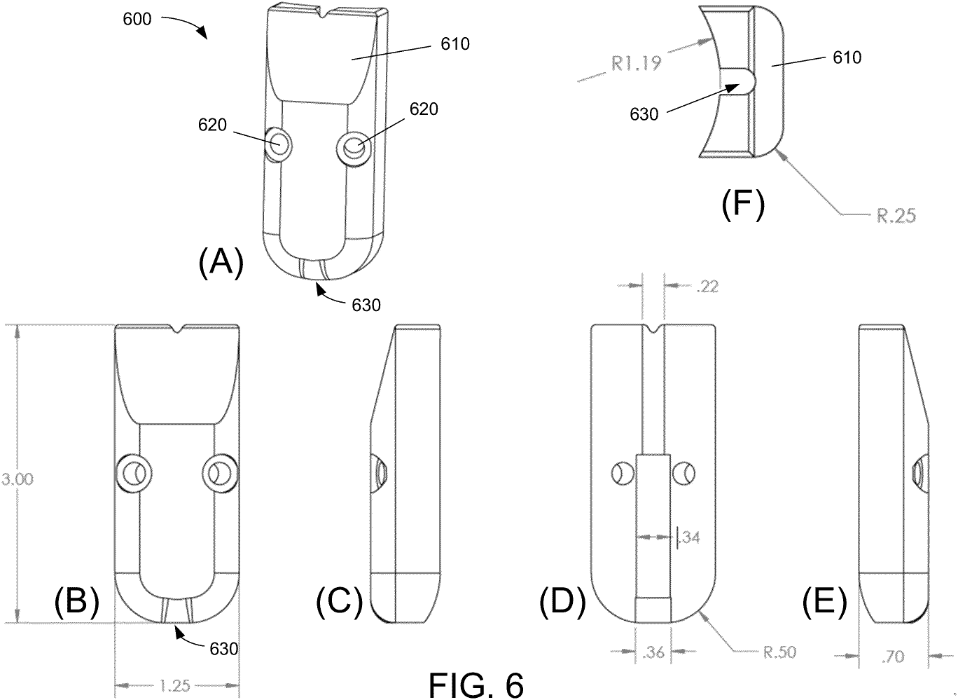

FIG. 5 is a view of the installation bar 160 near the proximal end 164 showing attachment of the orientation sensor 220 (e.g., compass the tilt sensor). The orientation sensor or orientation sensor module 220 includes an orientation sensor coupling plate 510, an orientation sensor circuit 520 affixed to the orientation sensor coupling plate 510, and an orientation sensor cable 530 connecting the orientation sensor circuit 520 to the proximal sensor cable 222 which is in turn connected to the major cable 240 via the breakaway cable connector 230 in FIG. 2. Fasteners such as three screws are used to attach the orientation sensor module 220 to the installation bar 160. The Y axis to which the sensor device 110 is pointed is shown pointing to the right side of the page.

FIG. 6 illustrates an example of a borehole camera 600 including (A) a perspective view, (B) a front elevational view, (C) a right side view, (D) a rear elevational view, (E) a left side view, and (F) a bottom plan view thereof. The camera 600 includes a camera housing 610 with a pair of holes 620 through which fastener such as screws can be used to fasten the camera housing 610 to the installation bar 160. The camera housing 610 has a concave surface to match the convex outer surface of the installation bar 160. The camera lens is pointed downward through the opening 630 to view the borehole 102 when the installation bar 160 is lowered into the borehole 102. The borehole camera 600 may be attached to any of a number of different locations on the installation bar 160 including an area near the distal end 162 thereof.

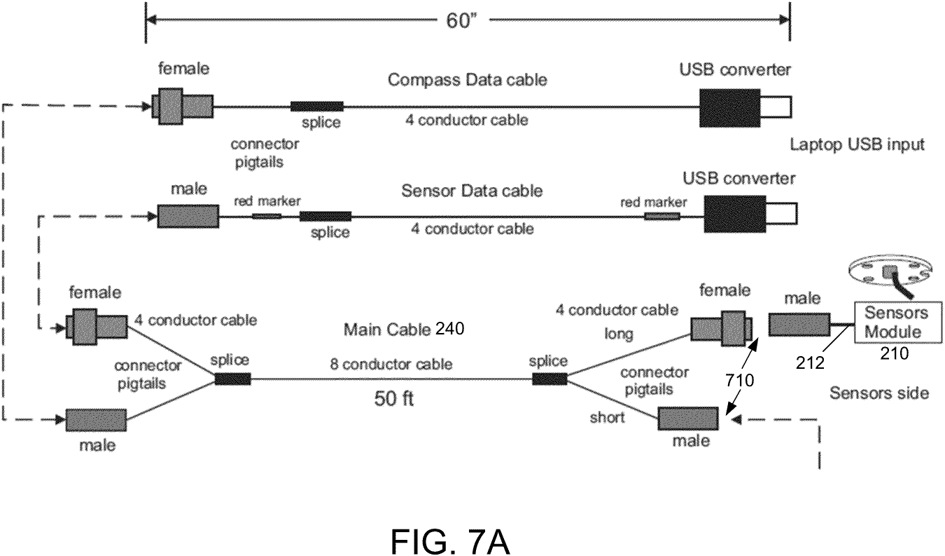

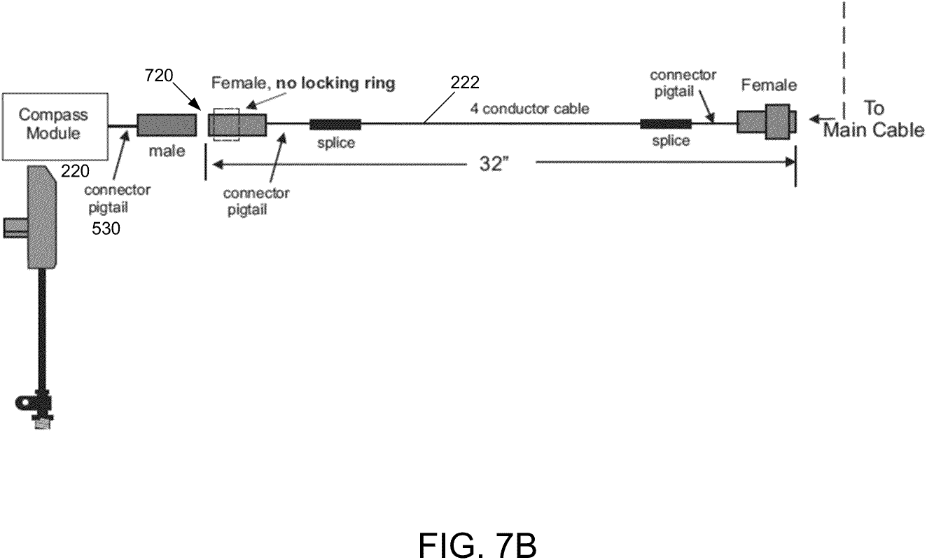

FIGS. 7A-7B illustrate details of the cable connections between the tilt sensor module 210 and a laptop computer at the surface above ground and of the cable connections between the orientation sensor module 220 and the laptop computer at the surface above ground. The cable connectors 710 may be modified to form breakaway connections such as the breakaway cable connection 230 shown in FIG. 2. Alternatively, a breakaway cable connection 720 may be provided between the orientation sensor cable 530 and the proximal sensor cable 222.

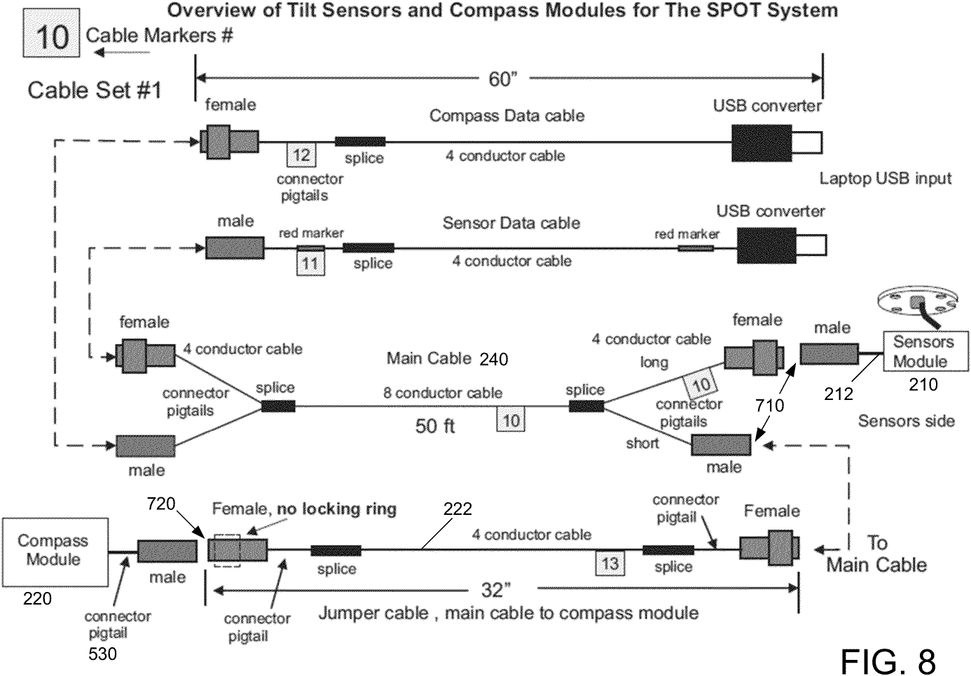

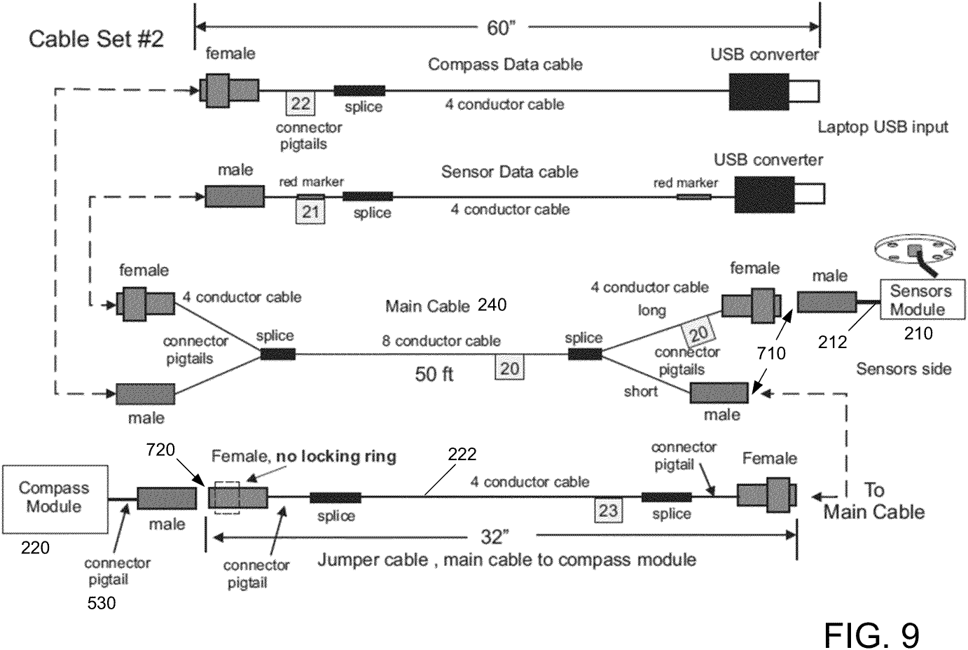

FIG. 8 illustrates cable set #1 having the cable connections of FIGS. 7A-7B and a first set of cable markers. FIG. 9 illustrates cable set #2 having the cable connections of FIGS. 7A-7B and a second set of cable markers.

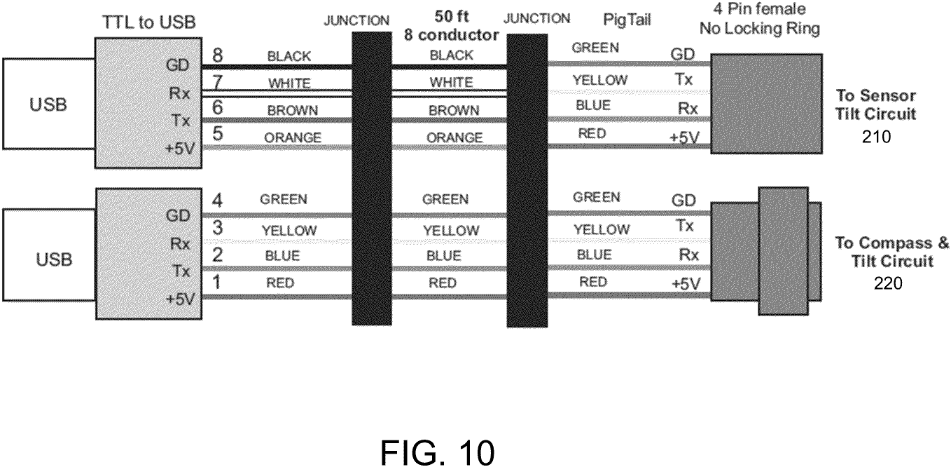

FIG. 10 illustrates an example of cable lines connecting the tilt sensor module 210 and the computer and of cable lines connecting the orientation sensor module 220 (compass & tilt) and the computer at the surface above ground. They each include a ground cable line GD, a voltage line +5V, a transmission line Tx and a receiver line Rx.

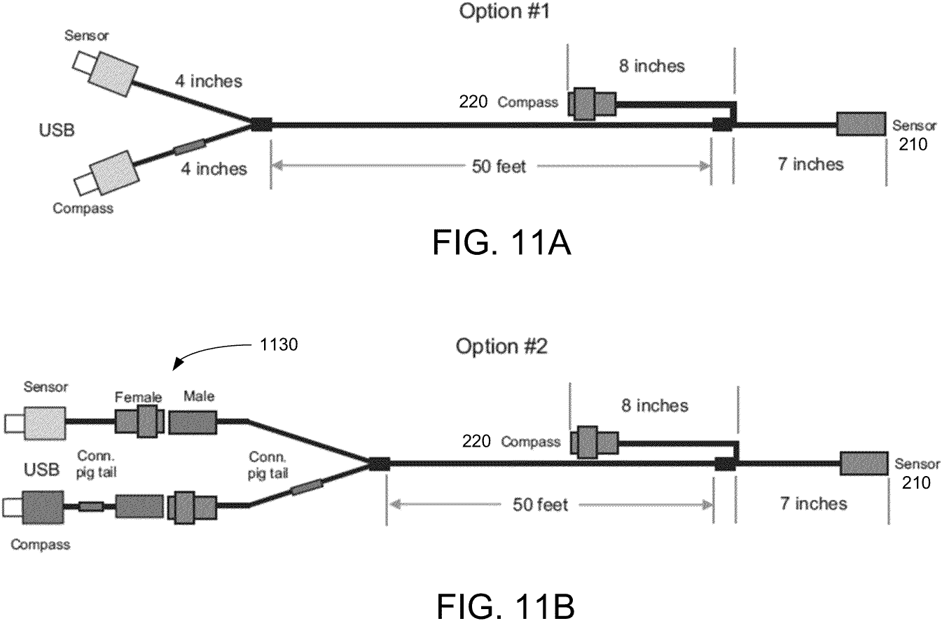

FIG. 11A shows an example of Option #1 of cable connections based on the configuration of cable lines in FIG. 10. FIG. 11B shows an example of Option #2 of cable connections based on the configuration of cable lines in FIG. 10. Option #2 has a pair of male-female connectors 1130 between a splice and USB connections to the computer for communication with the tilt sensor module 210 and the orientation sensor module 220, respectively.

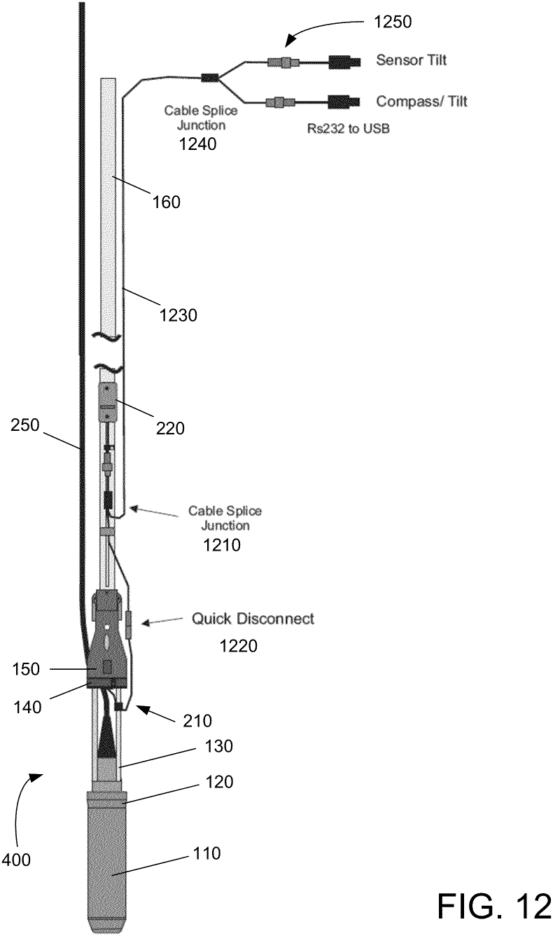

FIG. 12 is a view of the sensor device assembly 400 and installation tool illustrating another example of the cable connections. A distal cable splice junction 1210 is connected to the tilt sensor 210 via a quick disconnect 1220 and connected to the orientation sensor 220. A main cable 1230 connects the distal cable splice junction 1210 to a proximal cable splice junction 1240. The proximal cable splice junction 1240 is connected via a pair of male-female connectors 1250 to USB connectors for connecting with a computer to communicate with the tilt sensor 210 and the orientation sensor 220, respectively.

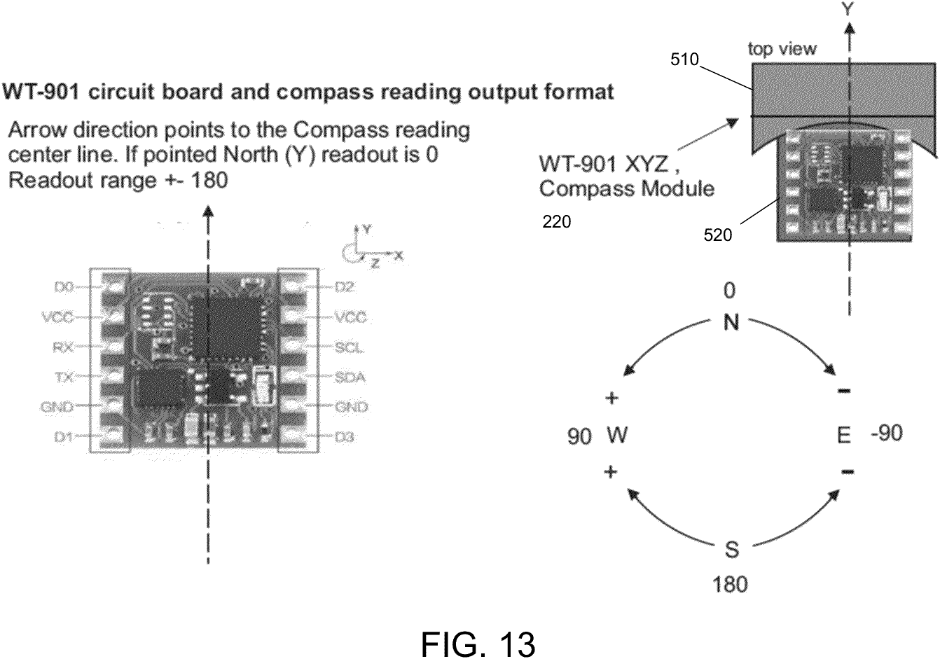

FIG. 13 is an example of the orientation sensor circuit 520 affixed to the coupling plate 510 of the orientation sensor 220. In this example, the Y axis of the orientation sensor 220 is configured to point to true North. The arrow direction points towards Y to the compass reading center line and has a readout range of ± 180 degrees.

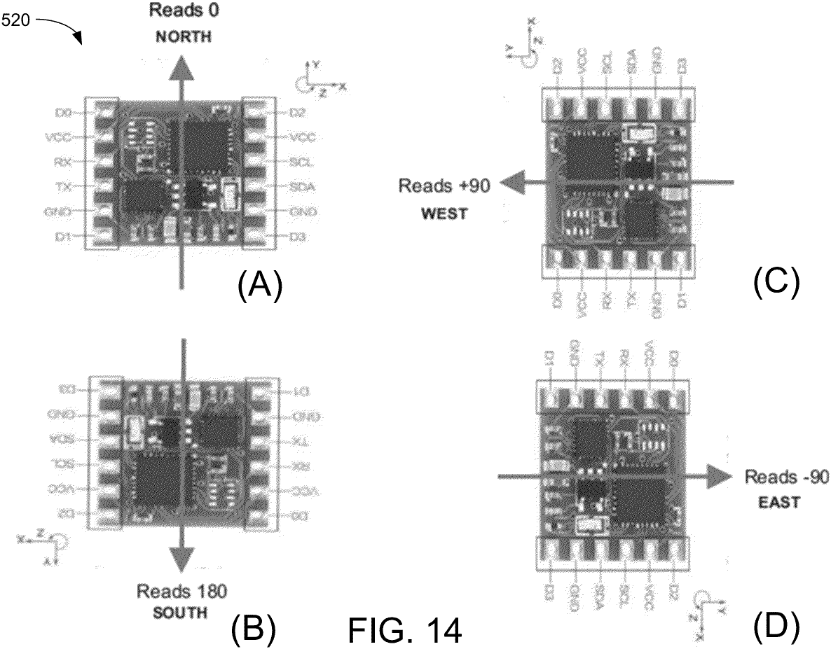

FIG. 14 is an example of a compass reading output format for the orientation sensor circuit 520. If the arrow direction points to North (Y axis), the compass readout will be 0. The compass readout is (A) 0 for North, (B) 180 for South, (C) +90 for West, and (D) -90 for East.

The orientation sensor circuit 520 is used to measure the direction of the Y axis toward which the sensor device 110 (e.g., geophone or SPOT sensor) is pointed. Because the installation rod 160 may twist while in the borehole 102, this will give another reference to the Y-axis direction to compare with a second compass located near the proximal end 164 of the installation rod 160 outside the borehole 102.

The compass in the orientation sensor module 220 may be used to determine the direction of true North. The compass readings must be corrected for two effects, however. The first is magnetic declination or variation, which is the angular difference between magnetic North (the local direction of the Earth’s magnetic field) and true North. The second is magnetic deviation, which is the angular difference between magnetic North and the compass needle due to nearby sources of interference such as magnetically permeable bodies or other magnetic fields within the field of influence. The magnetic deviation may be minimized by keeping the compass from any disturbing magnetic field (e.g., more than 20 cm from magnets, iron, or the like).

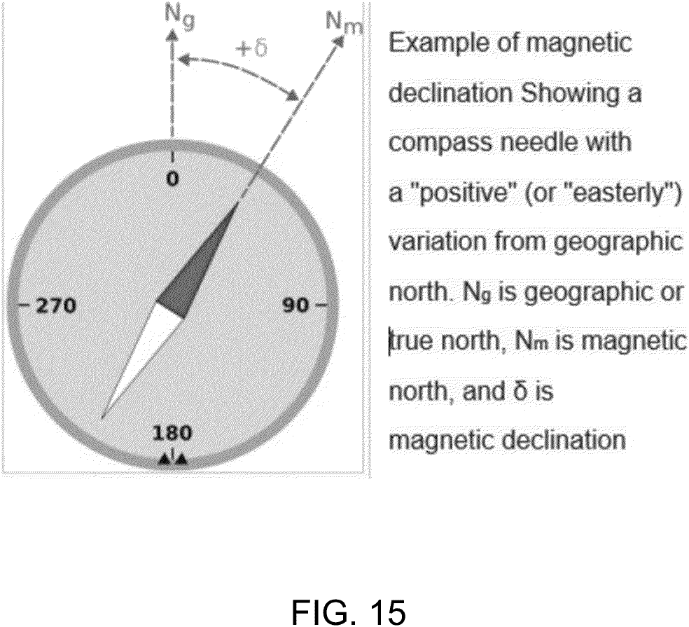

FIG. 15 is a view of a compass showing an example of magnetic declination. The compass needle has a positive (or easterly) variation from geographic North. N_{g} is geographic or true North, Nₘ is magnetic North, and δ is magnetic declination. For proper installation of the sensor device 110, the operator must take into account magnetic declination when reading the compass headings to know where the Y axis is pointed and either plotting directions on a map or entering directions in software.

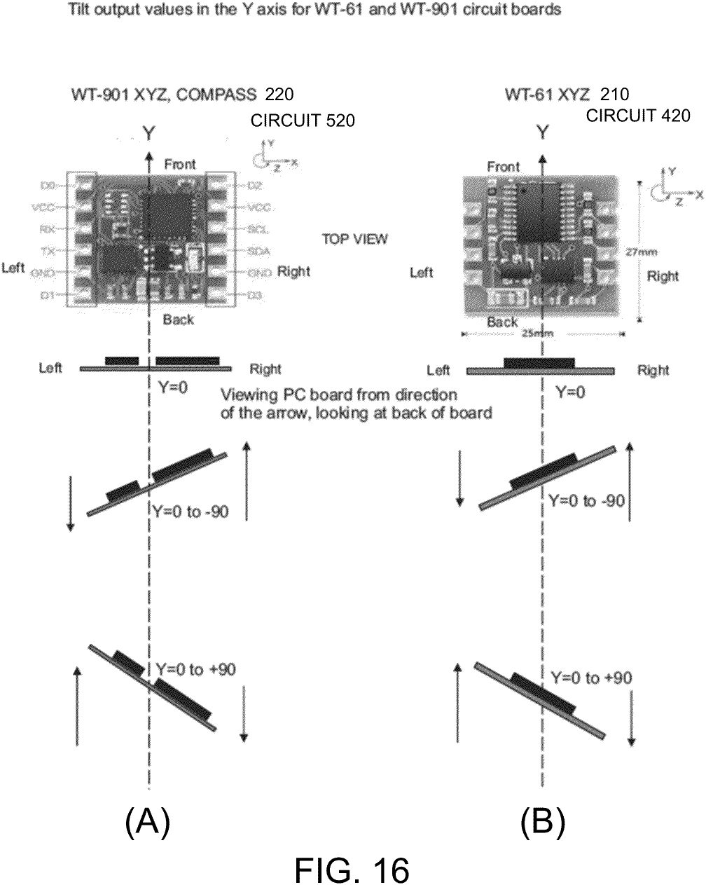

FIG. 16 is an example of tilt output values in the Y axis for (A) the orientation sensor circuit 520 and (B) the tilt sensor circuit 420. The output values are represented graphically by viewing the PC circuit board along the direction of the arrow at the back of the circuit (the tilt sensor circuit 420 for the tilt sensor 210 and the orientation sensor circuit 520 for the orientation sensor 220). FIG. 16 shows examples of Y=0, Y=0 to -90 and Y=0 to +90 in output values.

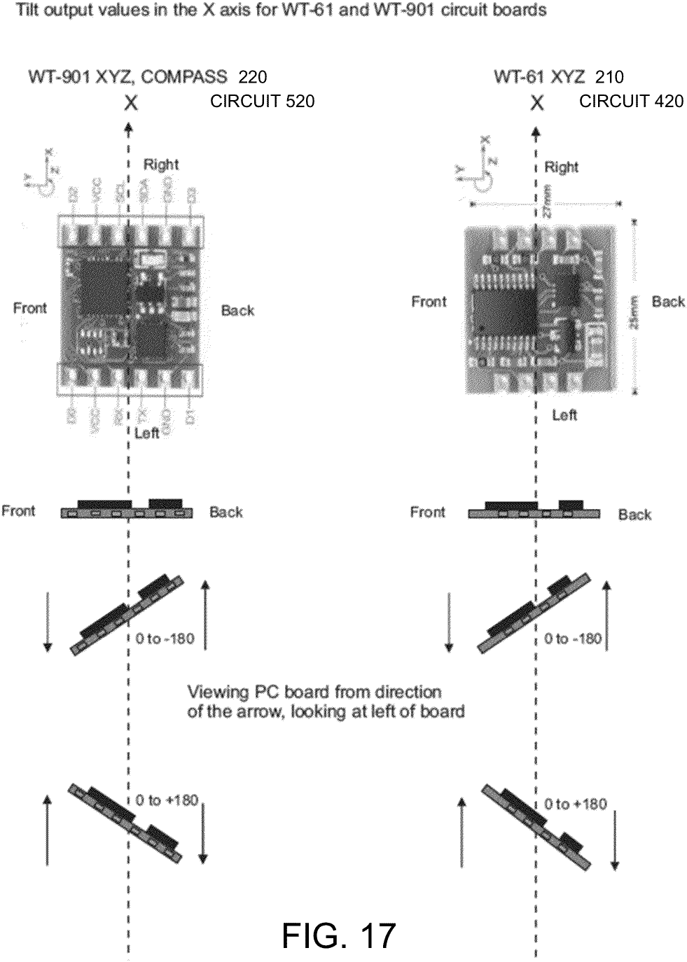

FIG. 17 is an example of tilt output values in the X axis for (A) the orientation sensor circuit 520 and (B) the tilt sensor circuit 420. The output values are represented graphically by viewing the PC circuit board along the direction of the arrow at the left side of the circuit (the tilt sensor circuit 420 for the tilt sensor 210 and the orientation sensor circuit 520 for the orientation sensor 220). FIG. 17 shows examples of X=0, X=0 to -180 and X=0 to +180 in output values.

### Sensor Device Installation Process

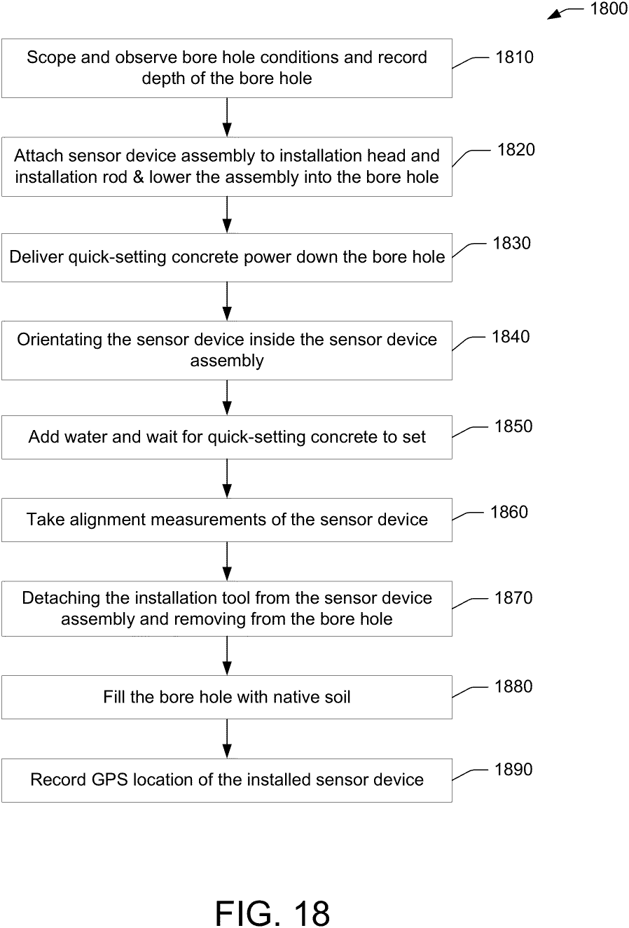

FIG. 18 is an example of a flow diagram 1800 illustrating a sensor device installation process using the installation apparatus 100. Step 1810 involves scoping and observing the borehole conditions and recording the depth of the borehole 102. Step 1820 involves detachably connecting the sensor device assembly 400 to the installation head 150 and the installation rod 160 and lowering the sensor device assembly into the borehole 102. Step 1830 involves lowering or delivering quick-setting concrete powder down the borehole 102. Step 1840 involves orientating the sensor device 110 inside the sensor device assembly. The sensor device 110 may be magnetically orientated and aligned by manipulating the installation rod 160 from outside the borehole 102 based on the compass and tilt sensor measurements from the tilt sensor 210 attached to the sensor assembly 400 and the compass and tilt (orientation) sensor 220 attached to the installation rod 160. Step 1850 involves adding water and waiting for the quick-setting concrete to set. The use of concrete is one way of setting the sensor device fixed in position inside the borehole 102. Other suitable methods may be used.

After setting of the concrete, step 1860 involves taking alignment measurements of the sensor device 110 again using the tilt sensor 210 and the orientation sensor 220. After confirming that the sensor device 110 is planted, step 1870 involves detaching the installation tool from the sensor device assembly 400 and pulling up the installation tool from the borehole. The detachment may make use of breakaway connections and/or quick disconnect connections or the like between the installation tool and the sensor device assembly 400. Step 1880 involves filling in the borehole 102 with native soil. Step 1890 involves recording the GPS location of the installed sensor device 110.

### Compass Calibration and Tilt Sensors Calibration Processes

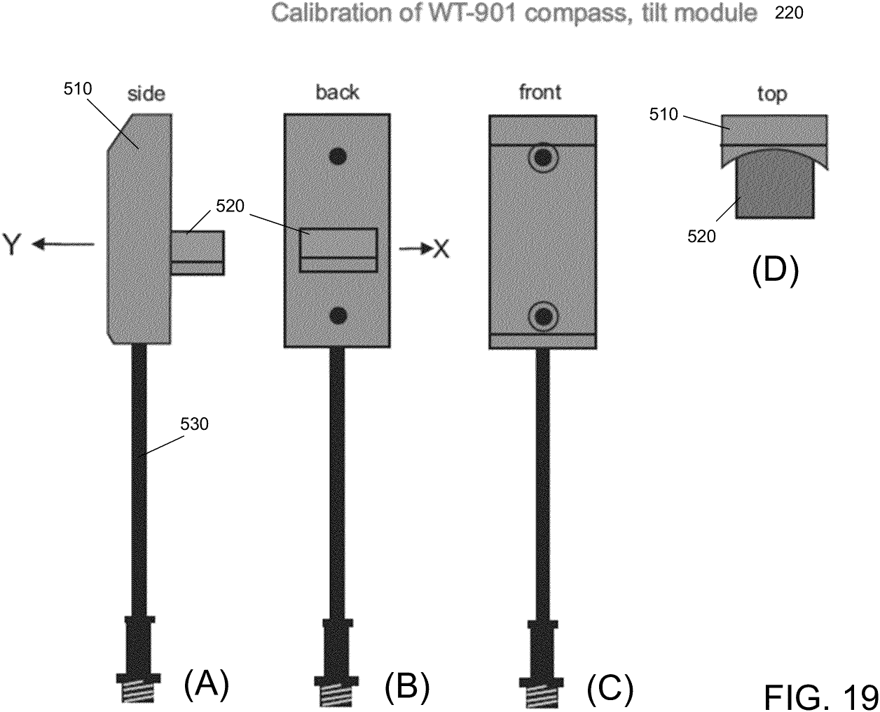

FIG. 19 shows the orientation (compass and tilt) sensor module 220 to be calibrated, in (A) side view, (B) back view, (C) front view, and (D) top view. The orientation sensor circuit 520 is affixed to the coupling plate 510 of the orientation sensor 220. In this example, the Y axis of the orientation sensor 220 is configured to point to true North.

Magnetic field calibration is used to remove the magnetic field sensor’s zero offset. Usually, the magnetic field sensor will have a large zero error when it is manufactured. If it is not calibrated, it may bring about a large measurement error and affect the accuracy of the Z-axis angle measurement of the heading angle.

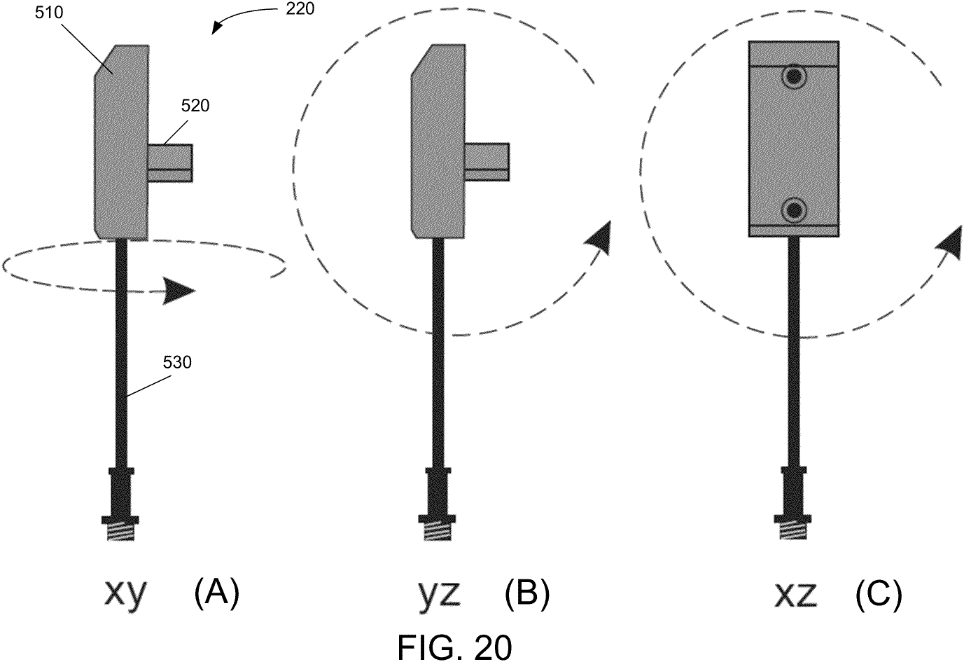

According to one embodiment of a calibration process, the first step is to connect the orientation sensor module 220 and the computer and place the orientation sensor module 220 far from any disturbing magnetic field (i.e., more than 20 cm from magnets, iron, or the like) and then open a computer calibration software. The second step is to set up the computer software for calibration. For instance, in the settings page, the operator clicks on the magnetic field button under the calibration bar to enter the magnetic field calibration mode. For a specific software program, a MagCal window pops up and the calibration button is clicked or selected. Then the third step is to rotate the orientation sensor module 220 slowly around the three axes and let the data points draw points in the three planes. FIG. 20 shows rotation of the orientation sensor module 220 for calibration around the three axes along (A) the Z axis, (B) the X axis, and (C) the Y axis. For a specific computer software, the data points produce a regular ellipse in each of the three planes. After the calibration is completed, the operator may click on Write Parameters for the specific software program. Prior to performing the calibration procedure, the orientation sensor module 220 is removed from the installation bar 160 to allow the rotation of the orientation sensor module 220 around the three axes as illustrated in FIG. 20.

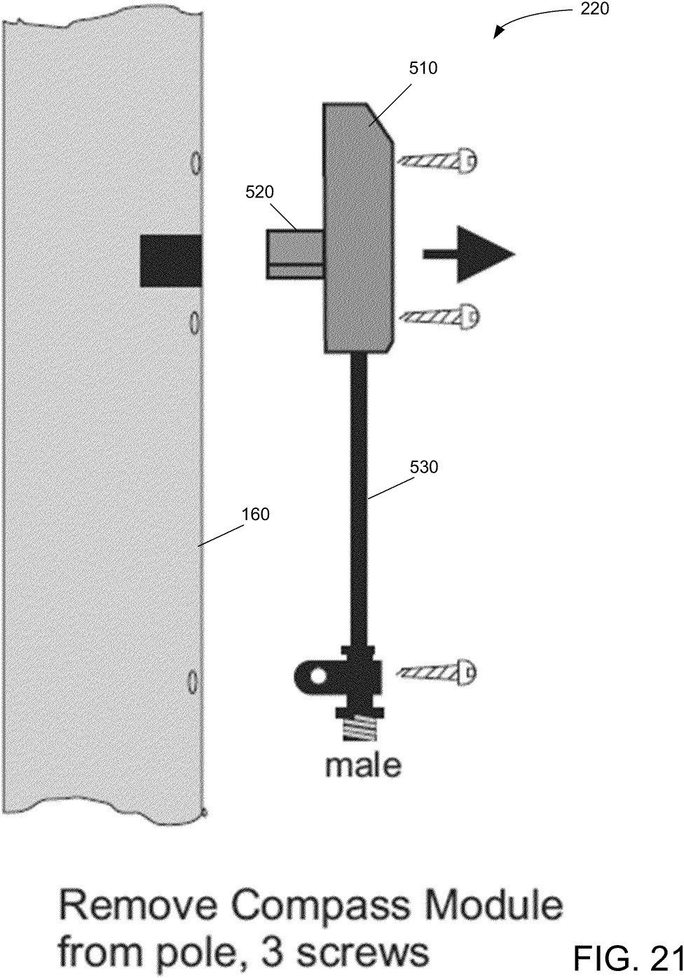

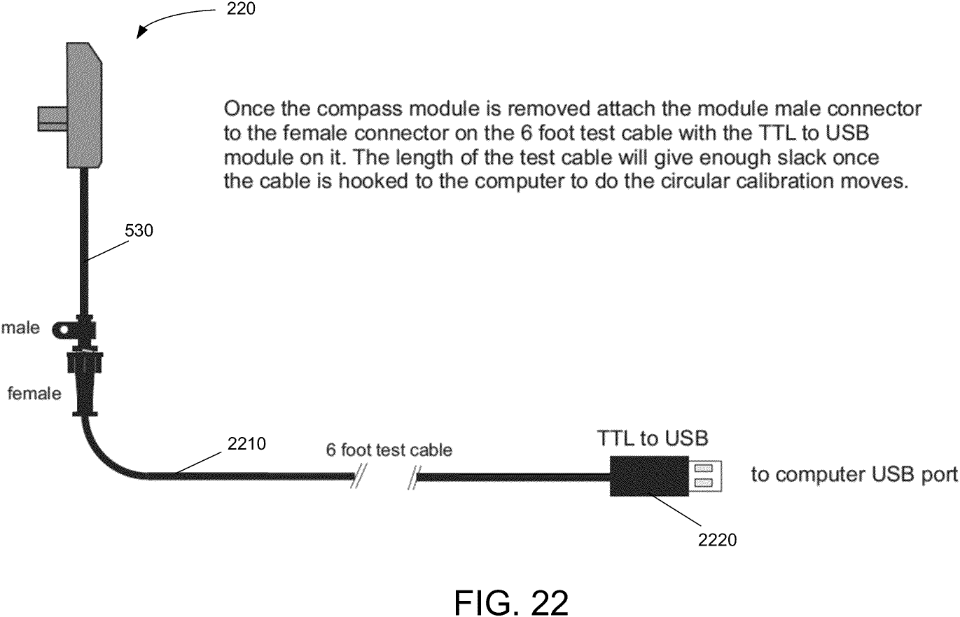

FIG. 21 illustrates removal of the orientation sensor module 220 (or the compass of the compass and tilt sensor module 220) from the installation bar 160. FIG. 22 illustrates connecting the removed orientation sensor module 220 of FIG. 21 to the computer. Once the orientation sensor module 220 is removed, the module male connector of the orientation sensor cable 530 is connected to a female connector of a long cable 2210 with a TTL to USB module 2220 for connecting to a computer. The length of the long cable will provide sufficient slack to allow the circular calibration movements. The calibration of the compass is performed first. Once the compass is calibrated, the orientation module 220 may be reattached to the installation rod 160 for XY tilt calibration.

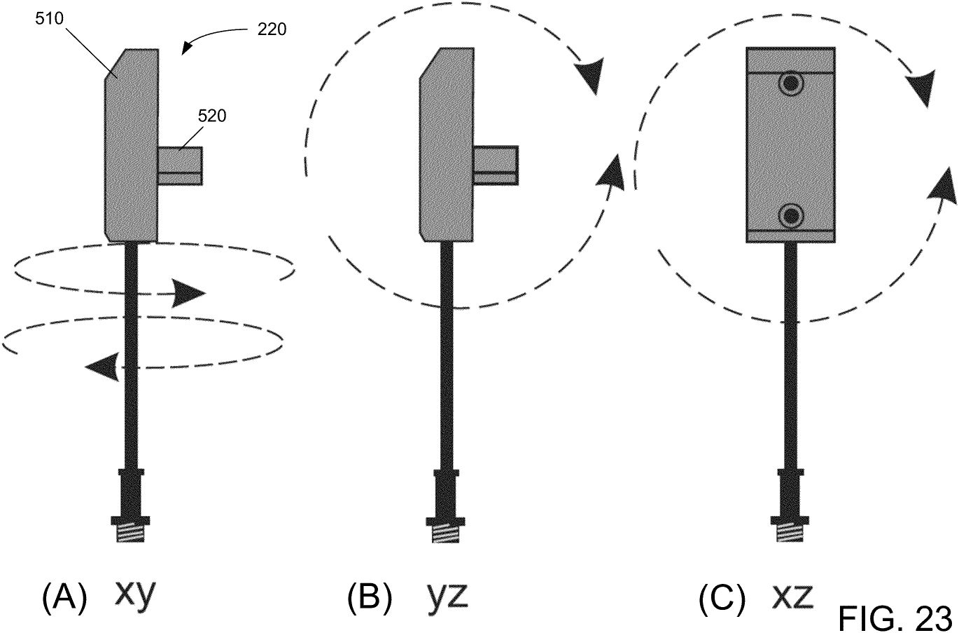

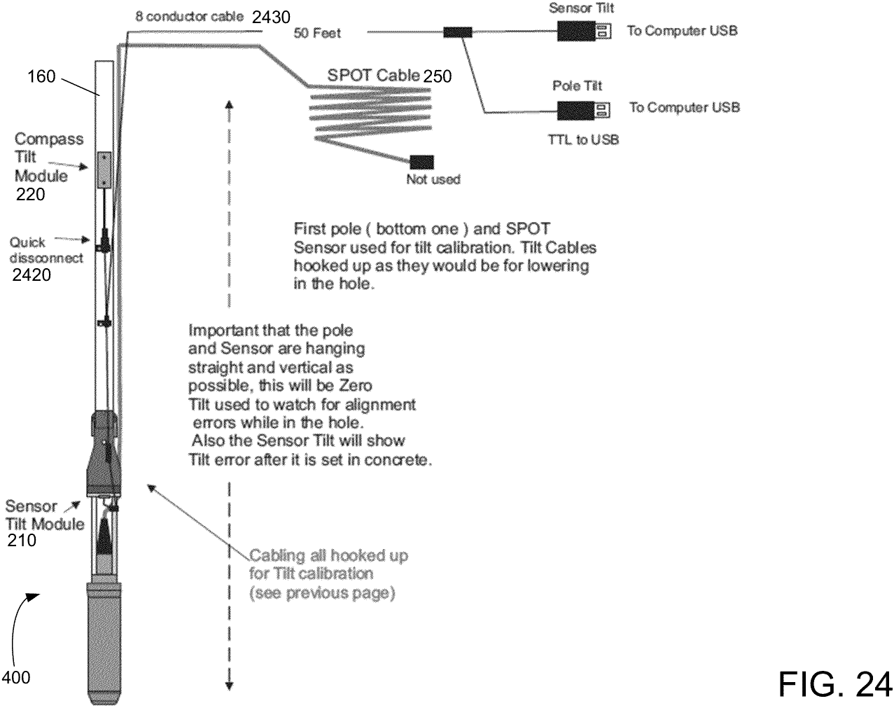

FIG. 23 shows rotation of the orientation sensor module 220 for calibration on (A) the XY plane, (B) the YZ plane, and (C) the XZ plane. The orientation sensor module 220 is rotated by 360° or more in both rotational directions on each plane.

FIG. 24 shows the sensor device assembly 400 and the installation tool set up for tilt calibration. The installation tool includes the installation bar 160 with the compass and tilt sensor module 220 attached thereto. The tilt sensor module 210 attached to the sensor device assembly is connected via a quick disconnect 2420 to a conductor cable 2430. The compass and tilt sensor module 220 is also connected to the conductor cable 2430, which is connected to the computer at the surface via a pair of TTL to USB modules to provide communication between the computer and the tilt sensor module 210 and the compass and tilt sensor module 220, respectively. The sensor device cable 250 (e.g., geophone cable or SPOT cable) is not used in the tilt calibration process. The tilt calibration involves angle X around the X axis and angle Y around the Y axis.

For X and Y tilt calibrations, it is important that (i) the tilt sensor module 210 and the compass and tilt sensor module 220 are mounted, (ii) the installation bar 160 is attached to the sensor device assembly 400 containing the sensor device 110 in an installation configuration as shown, (iii) the compass of the compass and tile sensor module 220 is installed, and (iv) the installation bar and the sensor modules 210, 220 are hanging as straight and vertical as possible so as to provide Zero Tilt which is used to check for alignment errors while the installation bar is in the borehole 102. The tilt sensor module 210 will show tilt error after it is set in concrete. A software program may be used to set the sensor tilt of the sensor device 110 to zero and set the sensor tilt of the compass and tilt sensor 220 to zero. This can then be used the reference to determine if the tilt of the sensor device 110 and the tilt of the compass and tilt sensor 220 are lined up and the same. If they are not, the software will show the alignment error as they are lowered into the borehole 102.

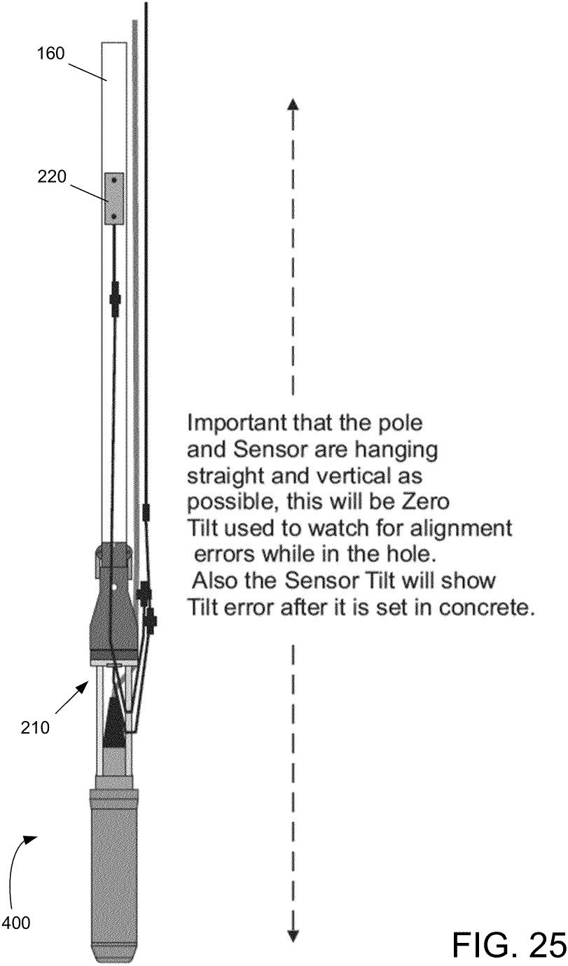

FIG. 25 shows the sensor device assembly 400 and the installation tool hanging straight vertically for zero tilt calibration. The tilt sensor 210 and the compass and tilt sensor 220 are hanging straight and vertical as much as possible for zero tilt calibration. The zero tilt is then used to watch for alignment errors while they are in the borehole 102. Any sensor tilt measurement after the sensor device assembly 400 is set in concrete will indicate tilt error.

As will be appreciated by one of ordinary skill in the art, the present invention may be embodied as an apparatus (including, for example, a system, a machine, a device, and/or the like), as a method (including, for example, a business process, and/or the like), as a computer-readable storage medium, or as any combination of the foregoing.

Embodiments of the invention can be manifest in the form of methods and apparatuses for practicing those methods.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. An apparatus for installing a sensor device to achieve a known magnetic orientation, comprising:
a distal tilt sensor configured to be attached to the sensor device to be installed into a borehole;
an installation tool configured to be detachably connected to the sensor device at or near a distal end of the installation tool to install the sensor device into the borehole; and
an orientation sensor configured to be attached to the installation tool at a location proximal of the distal end of the installation tool toward a proximal end of the installation tool, the orientation sensor including a compass and a proximal tilt sensor.

2. The apparatus of claim 1, further comprising:
a sensor device housing in which the sensor device is disposed, the distal tilt sensor comprising a distal tilt sensor circuit attached to a distal tilt sensor plate which is attached to the sensor device housing; and
a sensor device cable connected to the sensor device and extending to a location outside of the borehole;
wherein the sensor device is a geophone sensor.

3. The apparatus of claim 2, wherein the installation tool comprises:
an installation rod having the proximal end and the distal end of the installation tool; and
an installation head disposed at the distal end of the installation rod;
wherein the installation head is configured to form a breakaway connection with the distal tilt sensor plate.

4. The apparatus of claim 3,
wherein the installation head includes a magnetic plate to form a magnetic breakaway connection with the distal tilt sensor plate; and
wherein the orientation sensor is disposed sufficiently far from the magnetic plate to avoid magnetic interference with the compass.

5. The apparatus of claim 4,
wherein the orientation sensor is spaced from the magnetic plate by a distance of more than 20 cm.

6. The apparatus of claim 1, further comprising:
a camera attached to the installation tool.

7. The apparatus of claim 1,
wherein the orientation sensor is detachable from the installation tool for calibration.

8. A method for installing a sensor device to achieve a known magnetic orientation, the method comprising:
attaching a distal tilt sensor to the sensor device;
detachably connecting an installation tool to the sensor device at or near a distal end of the installation tool;
attaching an orientation sensor to the installation tool at a location proximal of the distal end of the installation tool toward a proximal end of the installation tool, the orientation sensor including a compass and a proximal tilt sensor;
lowering the sensor device into the borehole;
orientating the sensor device to achieve a known magnetic orientation based on the compass and tilt sensor measurements from the compass, the proximal tilt sensor, and the distal tilt sensor; and
setting the sensor device fixed in position inside the borehole.

9. The method of claim 8, wherein the sensor device is a geophone sensor disposed inside a sensor device housing and the distal tilt sensor comprises a distal tilt sensor circuit attached to a distal tilt sensor plate which is attached to the sensor device housing, the method further comprising:
connecting a sensor device cable to the sensor device, the sensor device cable extending to a location outside of the borehole.

10. The method of claim 9,
wherein the installation tool includes an installation rod having the proximal end and the distal end of the installation tool, and an installation head disposed at the distal end of the installation rod; and
wherein detachably connecting the installation tool to the sensor device comprises forming a breakaway connection between the installation head and the distal tilt sensor plate.

11. The method of claim 10, wherein the installation head includes a magnetic plate to form a magnetic breakaway connection with the distal tilt sensor plate, the method further comprising:
maintaining a sufficient distance between the orientation sensor and the magnetic plate to avoid magnetic interference with the compass.

12. The method of claim 8, further comprising:
attaching a camera to the installation tool to view the bore hole.

13. The method of claim 8, further comprising:
scoping and observing borehole conditions of the borehole and recording a depth of the borehole.

14. The method of claim 8, further comprising:
calibrating the distal tilt sensor and the orientation sensor before orientating the sensor device based on compass and tilt sensor measurements from the compass, the proximal tilt sensor, and the distal tilt sensor.

15. The method of claim 8, further comprising:
taking alignment measurements of the sensor device using the tilt sensor and the orientation sensor after setting the sensor device fixed in position inside the borehole.

16. The method of claim 8, further comprising:
detaching the installation tool from the sensor device and removing the installation tool from the borehole after setting the sensor device fixed in position inside the borehole.

17. The method of claim 16, wherein detaching the installation tool from the sensor device comprises:
pulling the installation tool to overcome a breakaway connection between the installation tool and the sensor device.

18. The method of claim 8, wherein setting the sensor device fixed in position inside the borehole comprises:
delivering quick-setting concrete powder down the borehole; and
adding water to the quick-setting concrete power.

19. The method of claim 8, further comprising:
filling in the borehole with native soil after setting the sensor device fixed in position inside the borehole.

20. The method of claim 8, further comprising:
recording a GPS location of the sensor device after setting the sensor device fixed in position inside the borehole.
